(19) United States
(12) Patent Application Publication
(10) Pub. No.: US 2010/0100579 A1
(43) Pub. Date: Apr. 22, 2010

(54) Decentralized signaling for distributed systems

(75) Inventor: Wei Kang Tsai, Irvine, CA (US)

Correspondence Address: WEI K. TSAI, 8 Young Court, Irvine, CA, 92617, US

(73) Assignee: Grasstell Networks LLC

(21) Appl. No.: 12/288,548

(22) Filed: Oct. 21, 2008

(51) Int. Cl. G06F 15/16

(52) U.S. Cl. 709/201

(57) ABSTRACT

Registration and deregistration of entities in a distributed directory, hosted in a distributed overlay network are carried out in a peer-to-peer manner. The overlay nodes are volatile as every node can attach to or detach from the overlay in an unpredictable manner. Therefore, the distributed directory is volatile as its entries are created and destroyed unpredictably, in accordance with the distributed registration process. The registration and deregistration process can use SIP or other protocols. Application-level connection setup is also carried out on an overlay of volatile nodes, in a peer-to-peer manner using IP as the communications protocol. The application-level setup is aided by a distributed search algorithm, which can be based on DHT (distributed hash table).

### FIELD OF THE INVENTION

The present invention relates in general, to control signaling for distributed computing, and more particularly, to registration and connection setup signaling for voice or video over IP, peer-to-peer applications, and cloud computing.

### BACKGROUND OF THE INVENTION

Distributed computing has been the Holy Grail for the computer and telecom industries for a long time. The great value of distributed computing stems from its massive scalability. With idealized distributed computing, there are no bottlenecks that constrain the performance per added resource: every additional unit of resource added to a system will yield an exact proportional unit of performance.

While idealized distributed computing is not achievable in real life, practical distributed computing is possible. The key is decentralization; the more a system is decentralized, the smaller is the number of bottlenecks in the system, and the higher is the scalability of the system. It is both intuitively clear and mathematically deducible that the degree of decentralization is directly proportional to the scalability of real systems. In the extreme when all subcomponents of a system are completely decoupled from one another, ideal scalability is achieved; the concern then is whether the system is useful.

Out of numerous efforts in distributed computing, two mega trends have emerged: P2P (peer-to-peer) networking and cloud computing. As both technologies are derived from distributed computing, decentralization is a key.

P2P networking has taken the Internet by storm: within a few short years, P2P traffic has completely dominated the Internet to the tune of 80% proportion. Numerous P2P applications now flourish over the Internet. It is no surprise that almost all applications over the Internet have moved or are mulling toward P2P architecture.

P2P systems now appear in just about every application imaginable: VoIP (voice or video over IP), media streaming (audio and video), file sharing, etc. In addition, P2P architecture also plays a key role in cloud computing.

According to Gartner Research, cloud computing heralds an evolution of business no less influential than e-business. While not everyone agrees, cloud computing can be defined as a style of computing wherein massively scalable IT-related capabilities are provided “as a service” using Internet technologies. The word “cloud” is a metaphor for the Internet.

As such, cloud computing is a broad computing paradigm encompassing a plurality of existing and newly developed technologies. Related technology paradigms include grid computing, virtualized computing, autonomic computing, and “everything as a service.”

From a business perspective, cloud computing encompasses a broad list of models including: SaaS (software as a service), utility computing, Web service in the cloud, PaaS (platform as a service), MSP (managed service provider), service commerce platforms, and Internet integration.

From a technology perspective, cloud computing is a form of distributed computing due to its extensive use of hardware virtualization—a key concept to utilize untapped hardware across the Internet. In accordance with this, computing tasks are performed by distributed sets of hardware, which can vary depending on availability of the resources in time and space.

To summarize, cloud computing is more business-driven while P2P networking is more technology-driven. It is important to realize that to achieve massive scalability envisioned in cloud computing, it is best and it has been suggested to utilize P2P technologies to gain the scalability associated with distributed computing.

Therefore, a key to maximize the return on the massive investments on P2P networking and cloud computing is to improve scalability by decentralization. Since P2P technologies are best to decentralize cloud computing, it is natural for the present invention to focus on P2P-based decentralization. To this end, it is important to recognize the difference between a data plane and a control plane.

A control plane is the part of a network that carries control information (also known as signaling). A data plane or user plane is the part of a network that carries its users' traffic.

A key characteristic of P2P systems is decentralization of data-plane operations. Thus all data-plane traffic, once connections have been set up, does not need centralized control. However, to set up a connection, currently a centralized control plane is deployed almost universally. Therefore, from a technical perspective, a logical next step is to decentralize control planes.

While existing P2P systems enjoy the benefits of a decentralized data plane, they still suffer from a centralized control plane. The present invention provides a method to establish decentralized control planes for two specific functions: registration and connection setup. These two functions are needed for all distributed systems; and in particular, for connection-orientated applications such as voice or video communications over IP.

Currently, a centralized control plane is often implemented by an infrastructure of servers, communications bandwidths and other IT facilities. To maintain and scale this infrastructure, the costs involve forecasting and planning, training new personnel, and licensing new software. Therefore, from the IT-department perspective, elimination of this infrastructure will dramatically improve the operating and capital expenditures.

Indeed, benefits of a decentralized control plane have been well known by those skilled in the art. One noted benefit of cloud computing is the ability to add IT capacities on the fly without investing in new infrastructure and the associated maintenance costs.

A major benefit from applying the present invention is elimination of a centralized control-plane infrastructure. In accordance with the present invention, a decentralized infrastructure is realized by a P2P system, comprising of only peer nodes, each with limited and approximately the same amount of computing, communications and information resources. Such nodes will be referred to as low-power nodes.

A key concept of P2P systems is that all nodes become peers: there is no longer a difference between servers and clients. A peer node is both a server and a client.

A fundamental problem associated with a P2P-structured decentralized control plane is that the peers are often volatile: peer nodes often attach and detach from the system spontaneously. A major contribution of the present invention is to provide a method to ensure smooth registration and connection setup in the face of volatile nodes.

Abstractly speaking, registration is regarding identifier management. In a distributed computing environment, an entity (which can be a hardware device, a software module, or a combination thereof), a user, and a service, must be uniquely identified and made known to relevant parties, within a relevant context.

Abstractly speaking, connection setup refers to establishing an application wherein two or more nodes communicate over an IP network. A connection setup involves two related process: route resolution, and application setup. The route resolution process is used to discover a reachable IP address (with a port number) for an intended destination of communication. The application setup process is used to exchange application setup parameters, and to establish an application-level connection.

In order to provide details for registration and connection setup, SIP-based VoIP systems are chosen as specific embodiments of the present invention. Here VoIP means either voice or video over IP.

Main components of a SIP-based VoIP system include VoIP servers, VoIP clients, PBX modules, and registrar modules. Since most VoIP servers and clients are SIP-based, they will be referred to as SIP servers and SIP clients also.

A VoIP server handles SIP client requests acting as a man-in-the-middle for establishing VoIP connections between clients. VoIP users utilize a VoIP client module to make phone calls to other users, while VoIP servers help set up the calls.

The purpose of a PBX module is to maintain a routing table. This routing table is used by VoIP-SIP servers to route calls throughout the system. A registrar module is responsible for storing user accounts and keeping track of the current status of each user (e.g. online/offline status).

Existing VoIP control plane solutions—such as the open standard SIP—are built with a centralized infrastructure (FIG. 2-201). Each VoIP client (FIG. 2-200, 202) is configured to communicate with one VoIP server (FIG. 2-201). When a client boots up, it registers its user information (e.g. the client's IP address and port number where it can be reached) with the VoIP server. When a caller makes a VoIP call, it first contacts the VoIP server. The server—which has enough information to route calls to any client in the system—then forwards the call to the callee. A centralized call setup for VoIP is summarized in FIG. 2.

The traditional VoIP (SIP-based or not) system is asymmetric in that, while clients have no knowledge of other clients, servers have complete knowledge of all the clients. From a business perspective, such design empowers a VoIP provider as a man-in-the-middle to facilitate VoIP call setup. The asymmetry gives a provider an unfair advantage to charge for their services. Consider the case when the actual voice/video calls are carried out in a P2P fashion; then the control plane has little or nothing to offer once calls have been set up. In fact, the main usage costs in P2P-based VoIP calls are incurred by users who pay for the bandwidths.

Therefore, it can be argued that, any VoIP provider that charges usage-time fees to users who already pay for bandwidths is reaping excess returns. The usage-time fees can come in the form of per-minute charges or monthly charges. This, unfortunately, is the case for cable, and to a lesser degree, traditional telecom operators. For PC-to-PC VoIP calls, there are usually no charges for call setup.

With the present invention, a centralized control plane can be replaced by a serverless decentralized infrastructure. Therefore, the capital and operating expenditures will be minimal, if not practically zero. Empowered by the present invention, it is possible to establish a new breed of VoIP providers that charges VoIP call setup in a fair way and gives consumers a true competitive pricing.

Currently, IETF (Internet engineering task force) is working to standardize a protocol for serverless SIP communications, called P2P-SIP. The present invention is related to the new standards as both P2P-SIP and the present invention have to realize the registration and connection setup functions. The present invention, however, is not restricted to SIP-based systems; while the standard is.

### BRIEF SUMMARY OF THE INVENTION

It is, therefore, an object of the present invention to provide a method for registration and connection setup for distributed computing.

It is, another object of the present invention to enable a decentralized control plane for applications including, while not restricted to, P2P applications, ad hoc networking, mesh networking, cloud computing, utility computing, virtualized computing, grid computing, autonomic computing, SaaS, Web service in the cloud, PaaS, MSP, service commerce platforms, Internet integration, voice over IP, video over IP, and “everything as a service.”

It is another object of the present invention to enable a control infrastructure embedded in distributed sets of overlay nodes without a centralized control structure.

It is another object of the present invention to enable registration of data items associated with entities which include, but are not restricted to, hardware devices, software modules, services, users, accounts, businesses, organizations, and combinations thereof.

It is another object of the present invention to enable application-level connection setup in an IP-based decentralized distributed system.

In accordance with one aspect of the present invention, a decentralized control infrastructure is implemented by an overlay of nodes, and each node can attach to and detach from the overlay in an unpredicted manner.

In accordance with one aspect of the present invention, the registration and connection setup control is specifically applied to vice or video over IP, using SIP or another protocol.

In accordance with yet another aspect of the present invention, each volatile node is equipped with a software construct, known to all nodes; and each node hosts a partial local directory of a distributed directory. Each node uses the software construct to determine a special node, to register or deregisters entities in the local partial directory in the special node.

In accordance with yet another aspect of the present invention, a method is provided that, if a reachable address of a destination node is unknown by an origin node, the origin node will treat an interim node as if it was the destination, and establish the desired application-level connection.

### BRIEF DESCRIPTION OF THE DRAWINGS

The above and other objects and features in accordance with the present invention will become apparent from the following descriptions of embodiments in conjunction with the accompanying drawings, and in which:

FIG. 1 describes the generic architecture of the VoIP embodiments.

FIG. 2 is a network diagram of the traditional VoIP network.

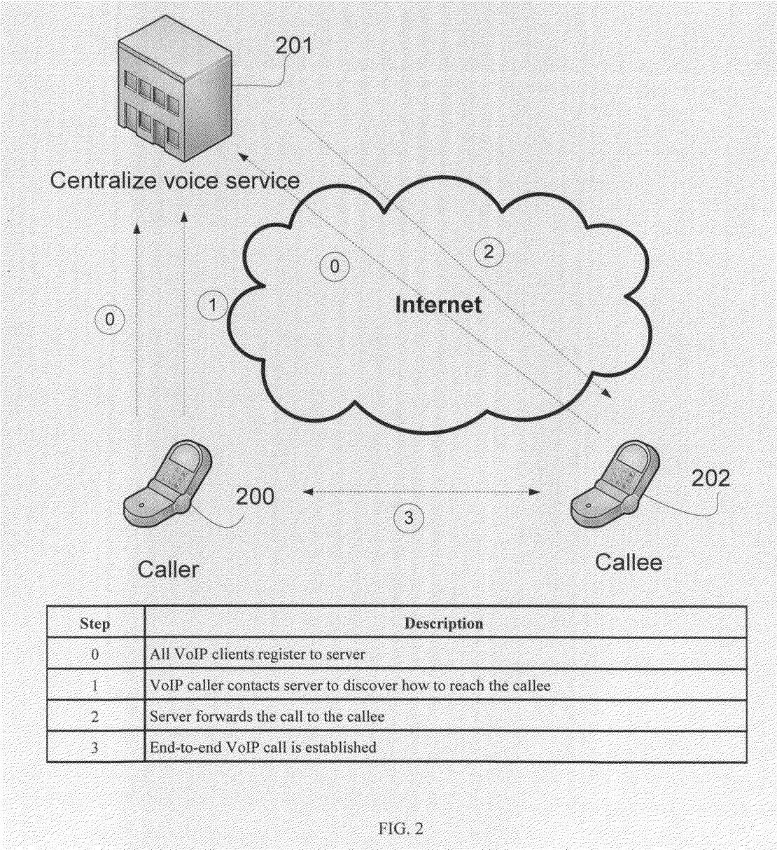

FIG. 3 is a network diagram describing the process of creating an account in traditional VoIP systems.

FIG. 4 is a network diagram describing the process of registering a user in a traditional VoIP system.

FIG. 5 shows a prototype of the IDT construct.

FIG. 6 shows the registration process using low-power nodes.

FIG. 7 shows an example of sip.conf file with two accounts, 9491112222 and 9491113333.

FIG. 8 is a flow chart of the process to route a call using a conventional VoIP network.

FIG. 9 shows how a conventional VoIP infrastructure is converted to a low-power-node VoIP system.

FIG. 10 is a flow chart of the process to route a call using low-power nodes.

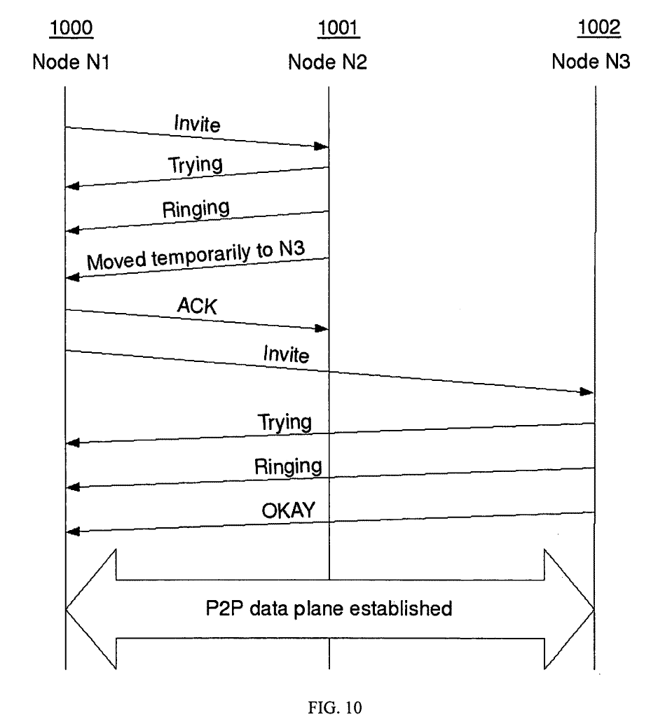

FIG. 11 is the same figure as FIG. 1 but showing the case of the VoIP client being physically separated from the rest of the system.

### DETAILED DESCRIPTION OF EXEMPLARY EMBODIMENTS

In a distributed computing paradigm, information is stored across different locations. To obtain information that is not locally available is, therefore, a crucial and necessary step. The registration process is a mechanism whereby a specific entity makes itself known to relevant nodes in a distributed system. The connection setup process is a mechanism whereby two or more nodes establish an application-level connection. The distributed system is assumed to be IP-based; therefore, each node is equipped with an IP routing table. A decentralized distributed system will be referred to as a flat distributed system.

While the utility of the present invention is suitable for all flat distributed systems, it is also possible that a flat distributed system is a component of a larger system with a non-flat (centralized) infrastructure. The noted difference between flat and non-flat systems is that in a non-flat system, there are bottleneck nodes that a large number of nodes must connect (directly or indirectly) to. This is often exemplified by centralized servers, as in practically all IT and telecommunications infrastructures today. In a flat system, there are no centralized servers.

The following assumptions will be made on flat distributed systems. All the nodes in such a system will be low-power volatile nodes, and the failure of any node will not affect the operations of the system in any material way. The nodes in the system are said to form an overlay, and a node is also known as an overlay node.

An overlay is a logical concept; it represents a set of nodes that possesses entities of a particular type, serving a particular function. Therefore, a physical node can serve as an overlay node in several different overlays.

One overlay example is a set of nodes hosting a VoIP directory, which maps VoIP user identifiers to Internet addresses—(IP address, port number) pairs. Likewise, each overlay is often associated with a directory, with each entry being a (identifier, address) pair.

To provide implementation details, VoIP (voice or video over IP) systems are used as embodiments of the present invention.

In a flat distributed system, an entity suitable for registration can be—while not being restricted to—any of the following: a software module, a hardware module, a user, an account, a record, an overlay node, or any combination thereof. For an entity to be made known to relevant audiences, a data item representing the entity must be stored in a distributed directory, and the storing process is called a registration process.

A realistic problem in a distributed system is that an intended destination has no reachable IP addresses in a locally available IP routing table. The route resolution process (a sub-process of connection setup) is deployed to discover reachable IP addresses.

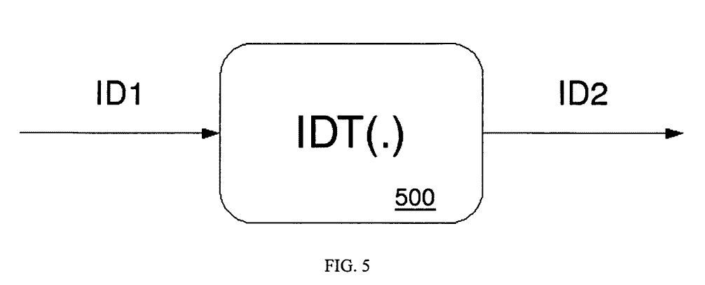

In the following descriptions a software construct called IDT(.) will be used. IDT is understood as a function that transforms an existing node identifier into another existing node identifier (see FIG. 5 for a definition of IDT's prototype). It is assumed that all the nodes in the system use the construct IDT(.). An identifier is a globally unique representation of an entity; for embodiments for VoIP systems, an entity is usually a user, or an overlay node representing a user's terminal.

Each node is set up to understand the semantics of registration. This requirement implies that each node is able to perform the registration of an entity from another node as if it was a server. All nodes are assumed to be equipped with the shared IDT(.) construct.

In accordance with one aspect of the present invention, a generic registration process proceeds as follows.

Each entity is bound to a globally unique entity identifier (EID), and each node is also bound to a globally unique node identifier (NID), both types of identifiers will be used in the registration process. When an entity E1 hosted in node N1 needs to register in an overlay directory, N1 will use the IDT construct to obtain another node identifier: N2=IDT(E1, N1). Then N1 send a registration message to N2, and causes E1 to be added to the overlay directory hosted in N2.

To deregister, two methods (method 1 and method 2) are available.

In method 1, node N1 explicitly sends a DEREGISTER message to node N2, to deregister entries associated with N1 and E1 from an overlay directory.

In method 2, all functions remain the same, except each entry in a directory is kept in a soft-state—each entry has a timer associated with it and that this timer is reset only when the entry is refreshed. Per this method, an entry needs to be kept alive by the registering node (the node that initiated the original registration). Entries that are not refreshed before their expiration timeouts are removed.

Method 2 is useful for maintaining graceful operations in the face of unexpected shutdowns of registered nodes—nodes may suddenly detach due to the loss of battery power, before sending DEREGISTER messages.

In an embodiment of the present invention, both methods above are implemented and coexist simultaneously in the system. In this case, nodes that are gracefully shut down will use method 1, whereas nodes that are ungracefully shut down will be deregistered via method 2.

In what follows, the registration process is now adapted to embodiments for voice or video over IP communication systems.

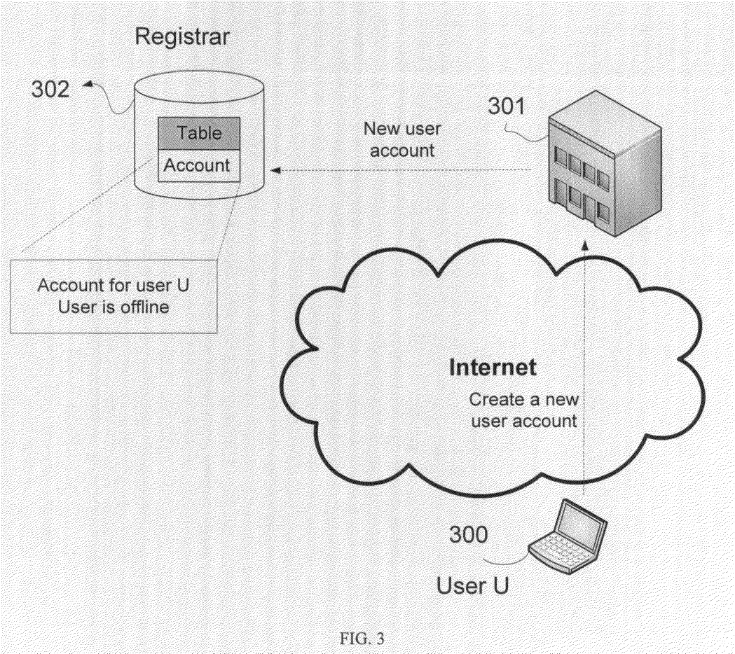

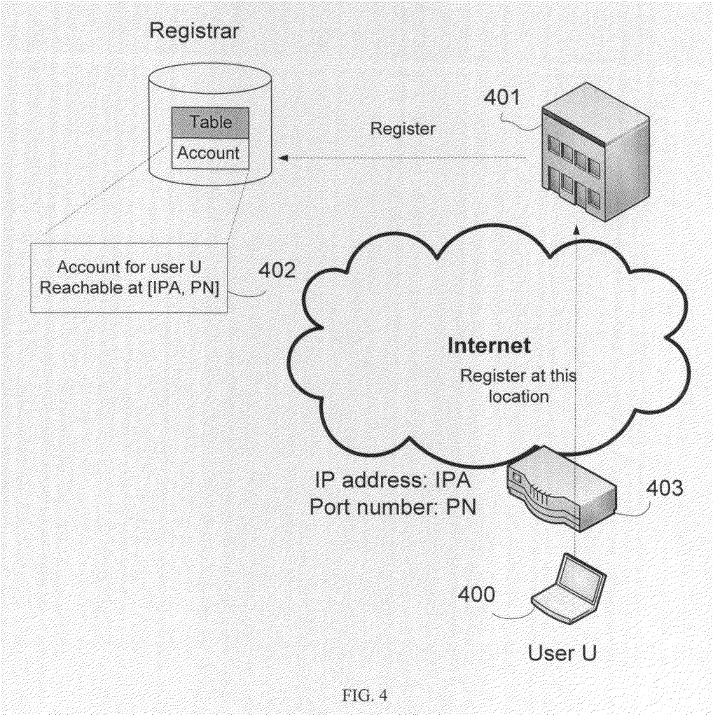

In a traditional VoIP system, nodes register to the system following a two-step process. The fist step only needs to be performed once in the lifetime of a subscriber and it involves the creation of a VoIP account with a VoIP provider. The VoIP provider stores the information of the new account in a centralized registrar (FIG. 3-302). This information remains stored in the system as long as the user remains a subscriber. The information contained in this new account includes a globally unique identifier (ID) bound to the subscriber. The second step is performed every time a user boots his VoIP terminal and connects it to the system. In the second step, the terminal will send a message to a centralized server to indicate that the user is now online and is reachable at a certain IP address and a certain port number (FIG. 4-403). This traditional two-step registration process is described in FIGS. 3 and 4.

In the following descriptions, the terms—user, subscriber, node and terminal—will be used interchangeably. A user or subscriber can also be identified with the node or terminal that he is using.

In an embodiment of the present invention, a method to register a user that merges the two-step registration process of the traditional VoIP system into one single step is accomplished.

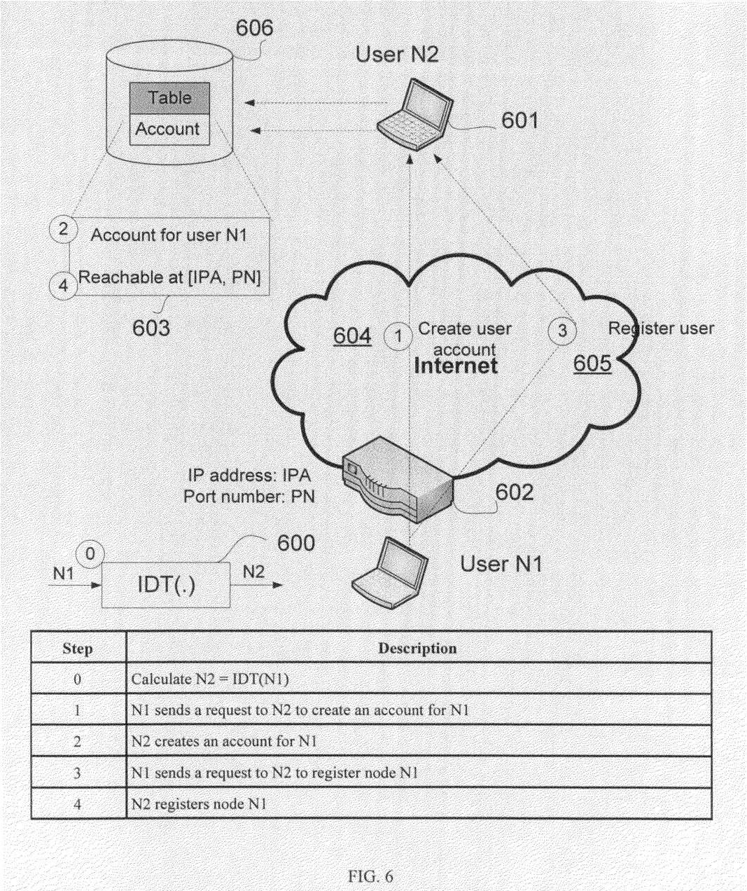

The process of registration is illustrated in FIGS. 6a and 6b. When an arbitrary node with identifier N1 is booted, it first uses the IDT construct (FIG. 6-600) to obtain another identifier (node): N2=IDT(N1). Then it performs two actions, one immediately after the other. First, it creates its own account in node N2 (FIG. 6-604). Second, it registers itself into node N2 using the newly created account (FIG. 6-605).

In traditional VoIP systems, accounts are only created once and are destroyed as users stop their subscriptions. However, in many embodiments for VoIP systems, accounts in the VoIP system are constantly being created and destroyed, as nodes are volatile. Such accounts will be called volatile accounts.

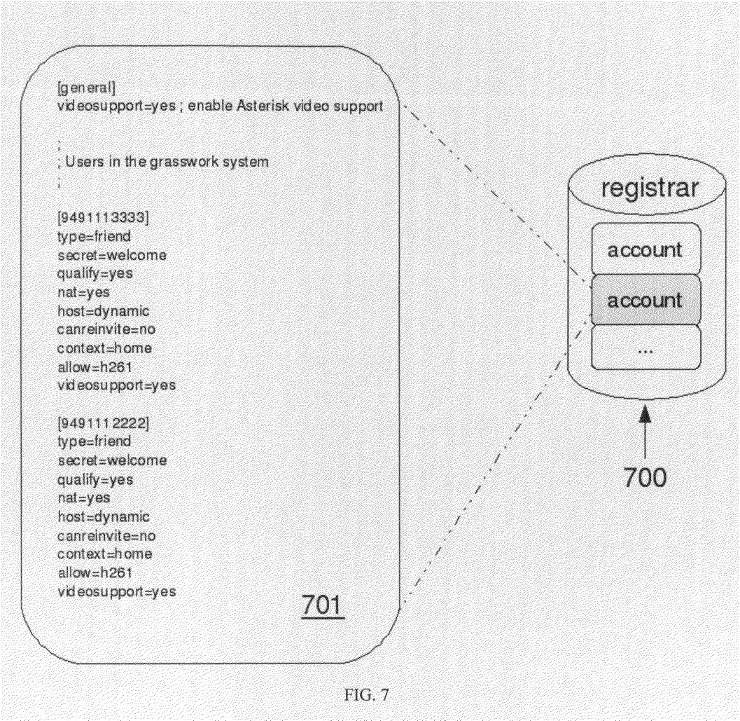

In yet another embodiment, the distributed registration procedure is integrated with a SIP infrastructure (for example, an Asterisk infrastructure; Asterisk is an open-source platform for SIP services). Asterisk servers keep user accounts in a file called sip.conf (see FIG. 7 for an example of sip.conf file). Since accounts are volatile, the account entries in the file sip.conf at a local node are modified every time nodes register and deregister locally. Therefore, with this modification in an Asterisk-SIP server will make its sip.conf file dynamic; constantly being modified in accordance with the distributed registration procedure.

Therefore, if a node is not attached to the system, then there is no record of that node in the system. This is an intended result, as the present invention eliminates the role of a network operator (man-in-the-middle), and in this case, a SIP-based VoIP operator. Since there are no operators needed to maintain the VoIP system, there is no need to track accounts, and therefore accounts are made volatile. Notice that if subscribers' accounts still need to be tracked—perhaps due to ancillary value-added services needing to maintain a billing infrastructure—a separate system has to be deployed.

In what follows, the connection setup aspects of the present invention are described in detail. The node attempting to make a connection to a destination is called the origin node, or simply the origin.

In a decentralized distributed system, the standard way to discover an unknown entity such as an IP address is to deploy a distributed search algorithm. One such algorithm is Chord—Chord is one of the DHT (distributed hash table)-based distributed search algorithms currently considered by the P2P-SIP standards committee within IETF. A distributed search algorithm deployed for route resolution will work as follows.

The origin node will contact a next node according to the search algorithm. If the next node is unable to resolve the IP address, it will contact the next node of the next node, and the process continues iteratively. The iterative process will terminate either in finding a reachable IP address or a conclusion is reached that the intended destination is offline (unreachable).

This process of iteratively looking for reachable IP addresses is referred to as an iterative route resolution algorithm, or simply an iterative route resolution.

The next nodes to search and the condition to determine whether a node is reachable are decided by the underlying distributed search algorithm. The present invention does not deal with the distributed search algorithm; rather, one object of the present invention is to establish application-level connections with the help of an iterative route resolution.

In accordance with one aspect of the present invention, a generic connection setup algorithm works as follows. In the pseudo code below the current node is initiated to be the origin node.

While the current node is not the destination;
a. Set the next node as the current node and proceed to make connection setup to the current node;
b. If current node is the destination, complete the connection setup and exit;
c. Otherwise, continue the while loop.

In what follows, the generic algorithm is adapted to flat VoIP systems. In the context of VoIP systems, connection setup is a form of call routing; therefore, the terms “connection setup” and “call routing” will be used interchangeably.

In a traditional VoIP system, calls are routed through the network as follows. First, a VoIP caller issues a call request to a centralized VoIP server infrastructure. Four messages are exchanged between the caller and the centralized SIP server infrastructure before a call can be established. First, an INVITE message from the caller to a server is issued.

The server then replies immediately with a TRYING message back to the caller, while at the same time it tries to establish communication with the callee. If the server successfully finds the callee, it will issue a RING message back to the caller indicating that the server is now ringing the callee.

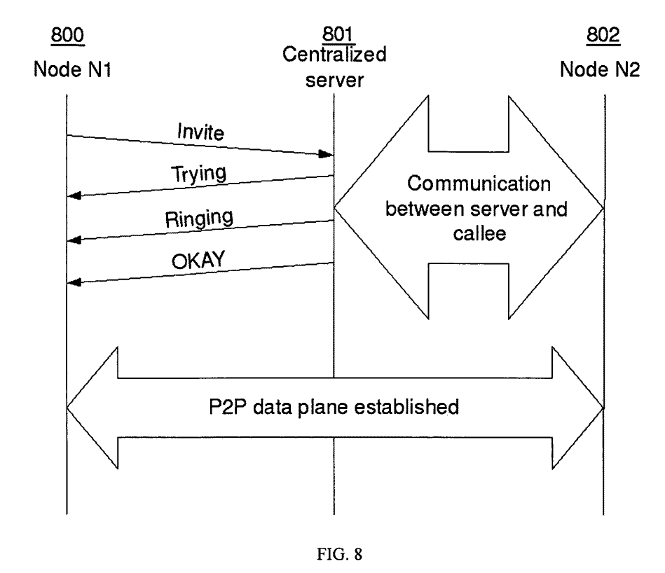

Finally, if the callee picks up the phone, the server will reply with an OKAY message back to the caller, at which point both the caller and the callee will be able to talk to each other. A data-flow illustrating this simple procedure is shown in FIG. 8.

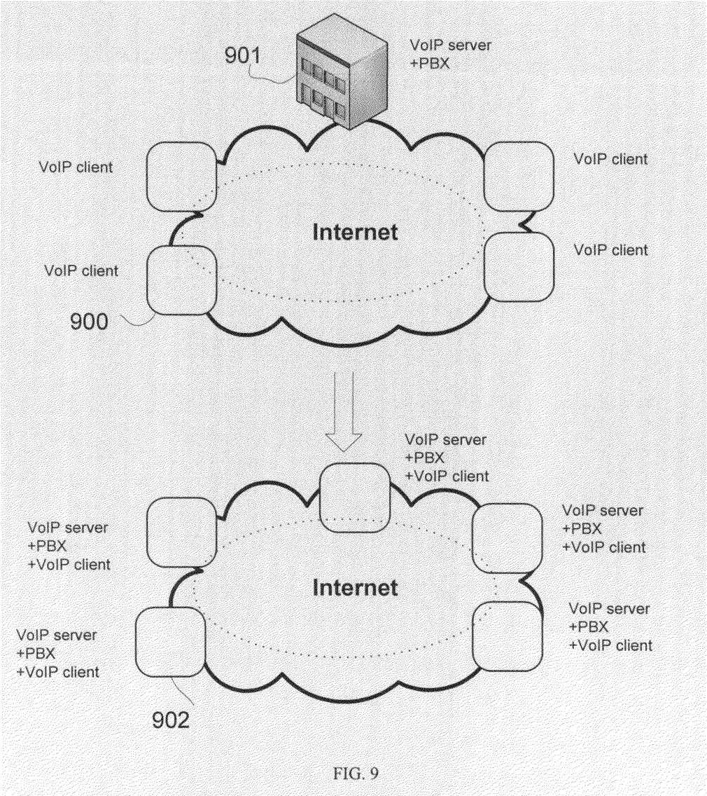

In an embodiment of the present invention, a combination of SIP semantics is used to establish a P2P connection between two parties, as is illustrated in FIG. 9. In this method, all nodes in the system are equally capable of performing the functions of (1) a VoIP server, (2) a VoIP registrar, (3) a PBX module, and (4) a VoIP client (FIG. 9-902).

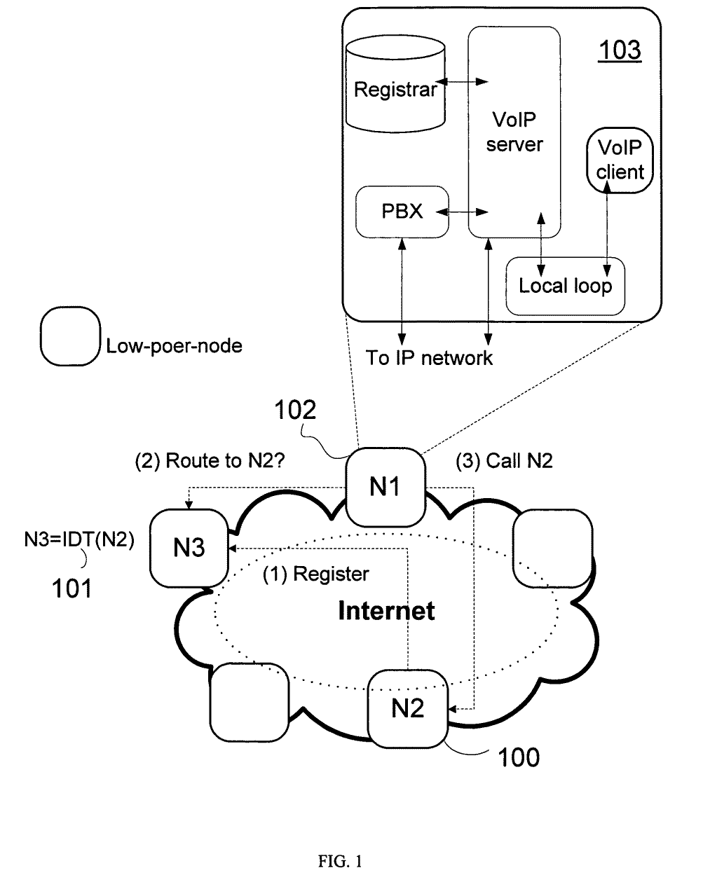

A caller with ID N1 starts a call to a node with ID N2 by issuing an INVITE message to its local VoIP server. Notice that in this specific embodiment, the VoIP server is located in the same physical node as the VoIP client, therefore both elements communicate through a local loop device (as shown in FIG. 1).

Following the standard behavior, the VoIP server will automatically respond with a TRYING and a RINGING message. At this point, the VoIP server invokes the local PBX module to find a reachable IP address for the callee. If such an IP address is available in the local PBX, then the call proceeds as in a conventional VoIP system. Otherwise, the following route resolution process is executed.

The server module then issues a SIP-based MOVED TEMPORARILY message, which includes a field called CONTACT indicating that the callee can be reached at a certain IP address. According to the SIP standard, a MOVED TEMPORARILY message is used by a user to indicate that he can be temporarily (or exceptionally) reached at a different IP address. This embodiment uses this type of message for a different purpose—that of routing a call through the VoIP system. With this method, every call to a callee whose IP address is not cached in the local PBX module will be routed through a MOVED TEMPORARILY type of messaging.

Upon receiving the MOVED TEMPORARILY message, the caller issues an ACK message to the local VoIP server and immediately issues a new INVITE request to the IP address indicated in the CONTACT field of the MOVED TEMPORARILY message.

At the conclusion of an iterative route resolution, assuming the callee is reachable, then the VoIP server located at the callee's node will receive the INVITE message from the caller and respond with a TRYING and a RINGING messages.

At this point, the callee's VoIP client starts ringing. Upon picking up the call, the SIP system will automatically route an OKAY message from the callee's VoIP client, passing through the VoIP server located at the callee's node, and finally reaching the caller's VoIP client.

Consider as an example the case of an Asterisk-based SIP infrastructure. Asterisk servers implement PBX functions and keep a routing table in a file called extensions.conf. In accordance with one aspect of the present invention, the file at a local node is modified every time a node updates its IP address, or registers or deregisters with the node.

For simplicity, the above description makes the assumption that the VoIP client is collocated in the same physical node as the VoIP server. However, without loss of generality, the same iterative routing described above can be applied to a system wherein VoIP clients are physically separated from VoIP servers.

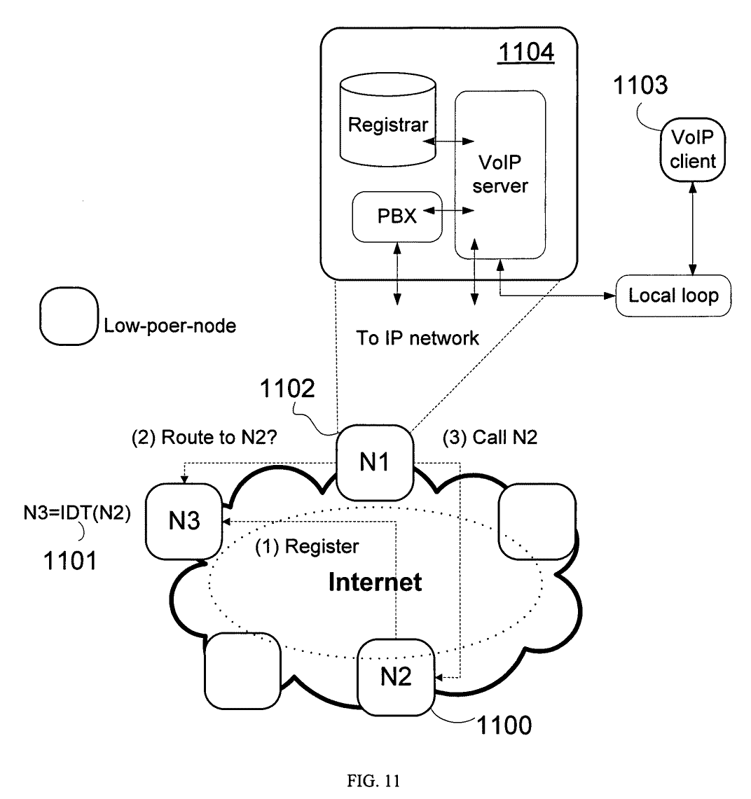

In yet another embodiment of the present invention, VoIP clients are connected to the rest of the system not by using an IP local loop (as shown in FIG. 1-103), but by using a generic IP connection (as shown in FIG. 11-1103).

A practical example of the latter case can be found in networks that are based on Wi-Fi access points. In this case, a low-power node consisting of a VoIP server, a PBX and a registrar can be implemented in each Wi-Fi access point. Then any Wi-Fi terminal with VoIP client capabilities (e.g. a Wi-Fi VoIP phone) can still use a VoIP telephony system by connecting to the Wi-Fi access point as described in FIG. 11-1103, with the Wi-Fi LAN replacing the role of a local loop.

What is claimed is:

1. A method to register and deregister entities in a distributed directory hosted in a peer-to-peer network, comprising:
a plurality of volatile peer nodes, forming an overlay network;
a plurality of entities hosted on said nodes; and
a distributed directory hosted on said overlay,
wherein said nodes may attach to or detach from said overlay in an unpredictable manner; each said node hosts a local partial directory of said distributed directory; and said entities hosted in certain said peer nodes are to be registered (added) to and deregistered (removed) from certain said local directories hosted in certain said peer nodes.

2. The method of claim 1, wherein a said entity is a member of the list: a user, an account, a record, an Internet address, a software module, a hardware device, a business, an organization, or any combination thereof.

3. The method of claim 2, wherein each said node is uniquely identified by a node ID, and each said entity is uniquely identified by an entity ID.

4. The method of claim 3, wherein each said node is equipped with a software construct IDT(.), and as a said node with ID N1 becomes attached to said overlay, N1 will choose a said node with ID N2, in accordance with the equation: N2=IDT (N1, E1) to register an entity E1, which is hosted on N1, onto a local directory hosted in node N2.

5. The method of claim 4, wherein said local directories on a plurality of said nodes keep the entries in soft-states; and for said entries, if the original registering nodes do not refresh the corresponding original registrations, will expire after timeouts.

6. The method of claim 6, wherein each said node hosts a local directory of accounts and the following operations are performed:
when a said node with identifier N1 boots, with N2=IDT(N1), N1 will create its own account in a certain said node N2, and register certain said entities onto a said local directory hosted in node N2 under the newly created account.

7. A computer-readable medium with a computer program for performing the method as described in any one of claims 1 to 6.

8. A method to set up applications over an IP network, comprising:
a plurality of volatile nodes, forming an overlay network;
each said node may attach to or detach from said overlay in an unpredictable manner; and
each said node is uniquely identified by its ID and hosts a routing table;
wherein a certain said node, as an origin node, establishes an application-level connection with certain said nodes, as destination nodes; each said routing table contains (ID, Internet address) pairs as entries, wherein an Internet address is a pair, (IP address, port number), representing a reachable address to communicate with a said node identified by ID, using the IP protocol.

9. The method of claim 8, wherein the following operations are performed to establish a said application-level connection between a said origin node and a said destination node:
a distributed search algorithm is used to discover a reachable Internet address of said destination node if needed;
as said distributed search algorithm progresses, said origin node is notified with newly updated interim Internet addresses for said destination node;
said distributed search algorithm will either terminate by making a reachable Internet address of said destination node as the last updated interim Internet address, or will inform said origin node that the destination is not reachable.

10. The method of claim 9, wherein a said origin node treats every newly updated interim Internet address as a reachable address for said destination, and make an application-level connection accordingly.

11. The method of claim 10, wherein a said origin node is notified with an updated interim Internet address via a MOVE TEMPORARILY message, as specified by a SIP protocol.

12. The method of claim 11, wherein a sad origin node functions as a SIP client, while a plurality of other said nodes in the overlay function both as a SIP server and a SIP client.

13. A computer-readable medium with a computer program for performing the method as described in any one of claims 8 to 12.
